(19) United States
(12) Patent Application Publication
(10) Pub. No.: US 2001/0027426 A1
(43) Pub. Date: Oct. 4, 2001

(54) Product ordering system and product ordering method

(76) Inventor: Takayuki Koganeya, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/817,048

(22) Filed: Mar. 27, 2001

(30) Foreign Application Priority Data
Mar. 31, 2000 (JP) 99068/2000

(51) Int. Cl. G06F 17/60

(52) U.S. Cl. 705/26

(57) ABSTRACT

A product ordering system of the present invention includes: a network; a salesclerk terminal connected to the network; a shop ordering system connected to the network; and an order reception system connected to the network. The salesclerk terminal includes a display element which displays various product information and a transmission element which transmits order information of a product to the order reception system by an instruction of the salesclerk. The order reception system includes a generation element which generates order identification information to identify the order information in response to reception of the order information, a registration element which registers the order identification information and the order information, and a transmission element which transmits the order identification information and the order information to the shop ordering system. The shop ordering system includes a registration element which registers the order identification information and the order information in response to reception of the order identification information and the order information.

### BACKGROUND OF THE INVENTION

The present invention relates to a product ordering system and a product ordering method, particularly to a product ordering system and a product ordering method in which a salesclerk places an order for a product via a network such as the Internet.

In a conventional product ordering method where the salesclerk of a shop or the like places an order for a product, for which an order was placed from a customer, to a company via a network such as the Internet, the salesclerk of the shop has been performed an order registration operation to ordering systems of the company to be ordered via a network and the shop. These have been performed to control intensively order information in the order system of the shop.

Referring to FIG. 6, a product ordering system of such a conventional type is constituted of a salesclerk terminal 110, an order reception terminal 120 placed in a company to be ordered, a shop server 130 placed in the shop and a network 200 for connecting these terminals and the server. The salesclerk accesses to the order reception terminal 120 via the network 200 by using the salesclerk terminal 110, decides a product which he/she wants to order and places an order on a screen of the terminal 110. Next, for an order control, the salesclerk registers order contents to the shop server 130 of the shop (own company) on the network 200 by using the salesclerk terminal 110.

However, in the conventional product ordering system, there has been a problem that the salesclerk of the shop had to perform the order registration operation separately to the two systems that are the order reception terminal of the company to be ordered and the shop server of the shop.

### SUMMARY OF THE INVENTION

The object of the present invention is to provide a product ordering system and a product ordering method, to which an order can be registered simultaneously to two ordering systems by one operation of a salesclerk.

According to one aspect of the present invention, a product ordering system is provided which includes: a network; a salesclerk terminal connected to the network; a shop ordering system connected to the network; and an order reception system connected to the network, wherein the salesclerk terminal includes a display element which displays various product information and a transmission element which transmits order information of a product to the order reception system by an instruction of the salesclerk, the order reception system includes a generation element which generates order identification information to identify the order information in response to reception of the order information, a registration element which registers the order identification information and the order information, and a transmission element which transmits the order identification information and the order information to the shop ordering system, and the shop ordering system includes a registration element which registers the order identification information and the order information in response to reception of the order identification information and the order information.

According to another aspect of the present invention, a product ordering method used in a system, in which a salesclerk terminal, a shop ordering system and an order reception ordering system are connected via a network, is provided which includes: displaying various product information on the salesclerk terminal; transmitting the product order information from the salesclerk terminal to the order reception system according to an instruction of the salesclerk; generating an order identification information for identifying the order information in the order reception system; registering the order identification information and the order information in the order reception system; transmitting the order identification information and the order information to the shop ordering system from the order reception system; and registering the order identification information and the order information in response to reception of the order identification information and the order information in the shop ordering system.

According to another aspect of the present invention, a information processing device used as an order reception system is provided which includes: a first receiving element which receives order information transmitted from a salesclerk by using a terminal; a first generating element which generates order identification information by using the order information; a registration element which registers the order information and the order identification information; a first transmission element which transmits the order information and the order identification information to a shop ordering system; a second receiving element which receives an order registration processing result, which is a result that the shop ordering system registered the order information and the order identification information to the shop ordering system; a second generating element which generates order registration result screen information to be displayed on the terminal of the salesclerk by using the order registration processing result and the registration result of the registration element; and a second transmission element which transmits the order registration result screen information to the terminal of the salesclerk.

### BRIEF DESCRIPTION OF THE DRAWINGS

Other features and advantages of the invention will be made more apparent by the following detailed description and the accompanying drawings, wherein:

FIG. 1 is a block diagram showing an embodiment of the present invention;

FIG. 2 is a view showing an operation of a first embodiment of the present invention;

FIG. 3 is a view showing a screen example to be displayed on a salesclerk terminal of the present invention;

FIG. 4 is a view showing an operation of a second embodiment of the present invention;

FIG. 5 is a view showing an operation of a third embodiment of the present invention; and

FIG. 6 is a block diagram showing a conventional product ordering system.

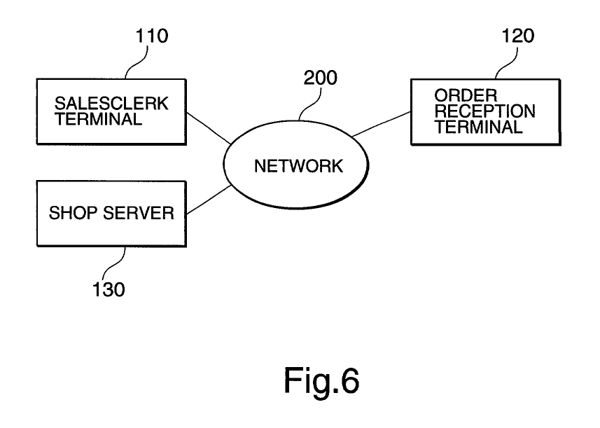

In the drawings, the same reference numerals represent the same structural elements.

### DETAILED DESCRIPTION OF THE PREFERRED EMBODIMENTS

A first embodiment of the present invention will be described in detail below.

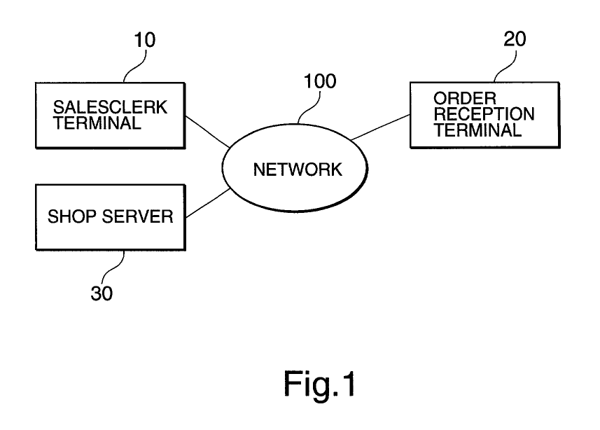

Referring to FIG. 1, the first embodiment of the product ordering system of the present invention is constituted of a salesclerk terminal 10, an order reception terminal 20, a shop server 30 and a network 100 for connecting these terminals and the server such as the Internet.

The salesclerk terminal 10 is an information processing device such as a personal computer. The salesclerk terminal 10 comprises an element for accessing the product information provided by the order reception terminal 20 on the network 100 and for displaying the product information on the screen. The product information is the one regarding products such as, for example, personal computers, PC servers, and software, which includes a product name, a type number, an article number, a price and the like. The salesclerk terminal 10 further includes an element for transmitting order information, which is the product information of a product that is desired to be ordered by the salesclerk, to the order reception terminal 20 via the network 100 according to an order from a customer.

The order reception terminal 20 is used by a company that is an order destination of the product, and is constituted of an information processing devise such as a server. The order reception terminal comprises: a first receiving element for receiving the order information sent from the order identification information by an operation of the salesclerk; a first generating element for generating the order identification information to add it to the order information; and a registration element for registering these order information and order identification information.

The order reception terminal 20 further includes a first transmission element for transmitting the order information and the order identification information to the salesclerk terminal 10 and the shop server 30 via the network 100.

The order reception terminal 20 further includes: a second receiving element for receiving an order registration processing result that is a result in which the shop server 30 (shop ordering system) has registered the order information and the order identification information to the shop server 30; a second generating element for generating an order registration result screen information to be displayed on the salesclerk terminal 10 by the use of the order registration processing result and the registration result in the registration element; and a second transmission element for transmitting the order registration result screen information to the salesclerk terminal 10.

In the order reception terminal 20, the first and second receiving elements may be constituted as one receiving element. The first and second transmission elements also may be constituted as one transmission element.

The shop server 30 is used by a shop of the product, and is constituted of an information processing device such as a server. The shop server 30 comprises an element for receiving and registering the order information and the order identification information sent from the order reception terminal 20. The shop server 30 further includes an element for transmitting the order registration processing result to the salesclerk terminal 10 or the order reception terminal 20 via the network 100.

Next, the operation of the embodiment will be described. Note that, in the following description, the network 100 shall be the Internet.

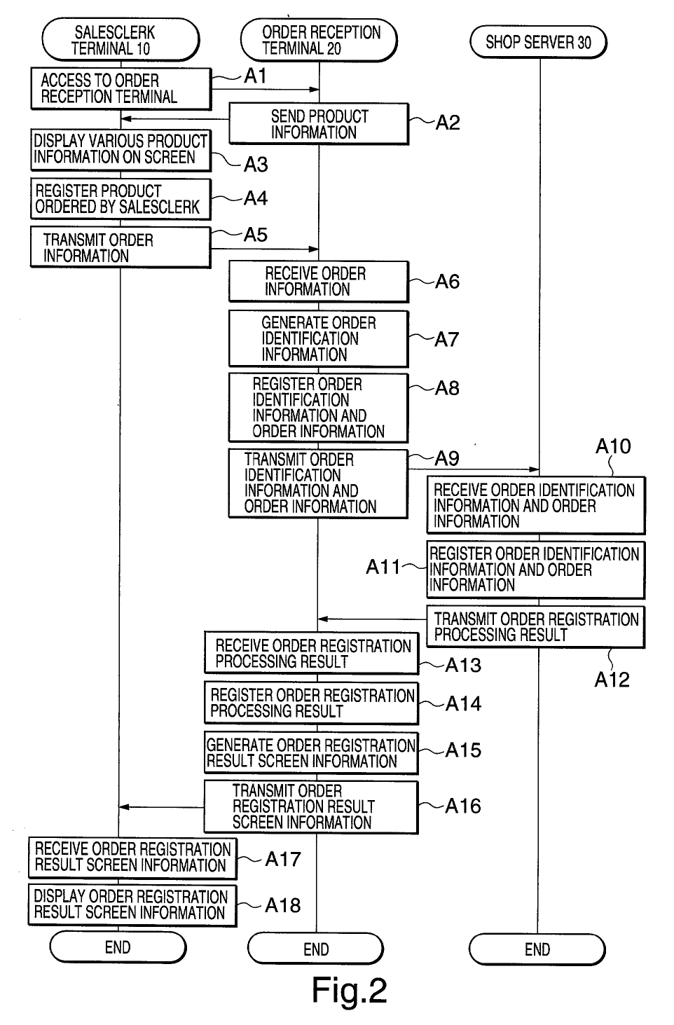

Referring to FIG. 2, the salesclerk accesses to a product ordering homepage, which is created by the order destination company in the order reception terminal 20 on the Internet 100, via his/her own salesclerk terminal 10 (step A1). In response to this, the order reception terminal 20 transmits the product information to the salesclerk terminal 10 (step A2).

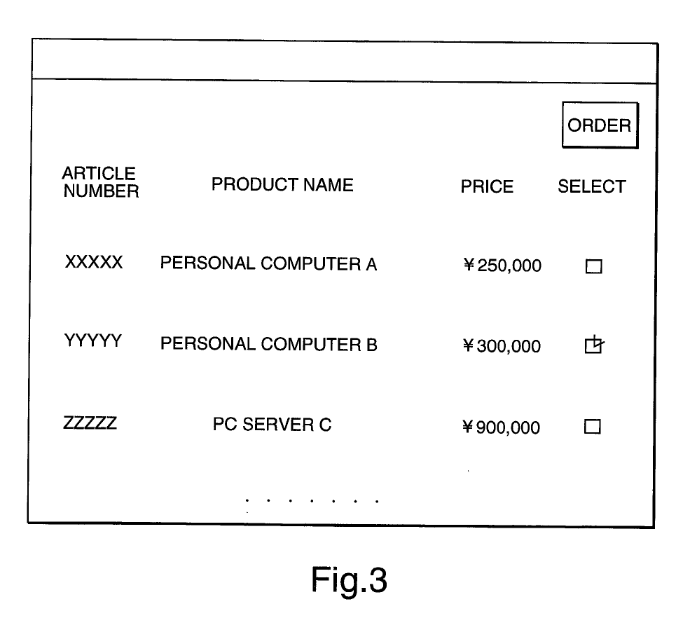

Firstly, various product information as shown in FIG. 3 is displayed on the screen of the salesclerk terminal 10 (step A3). The salesclerk, after looking at the various product information displayed on the screen of the salesclerk terminal 10, decides a product that he/she wants to order, and registers an order of the product on the screen (step A4). In the example of FIG. 3, when the salesclerk clicks on a select column with a mouse on a personal computer B, the select column is checked for order registration (check mark is shown). The product information of the product ordered by the salesclerk, which is registered in such a manner, is temporarily stored in the salesclerk terminal 10 as the order information.

Next, when the salesclerk clicks on an ‘order’ button on the screen of FIG. 3 with the mouse, the salesclerk terminal 10 transmits the order information to the order reception terminal 20 via the Internet 100 (step A5).

When the order reception terminal 20 receives the order information (step A6), it generates the order identification information for identifying the order (step A7). The order reception terminal 20 stores the generated order identification information and the order information in a order database for order registration (step A8). The order reception terminal 20 transmits the order identification information and the order information to the shop server 30 via the Internet 100 (step A9).

When the shop server 30 receives the order identification information and the order information (step A10), it stores them in the order database for order registration (step A11). The shop server 30 transmits the order registration processing result to the order reception terminal 20 via the Internet 100 (step A12).

The order reception terminal 20, after receiving the order registration processing result from the shop server 30 (step A13), stores it in the order database (step A14). The order reception terminal 20 generates order registration result screen information for confirming the order registration processing result from the shop server 30 with the order registration processing result thereof (step A15), and transmits the screen information to the salesclerk terminal 10 via the Internet 100 (step A16).

The salesclerk terminal 10, after receiving the order registration result screen information (step A17), displays it on the screen (step A18). The salesclerk can confirm that the order has been registered to the order reception terminal 20 and the shop server 30 by the use of his/her salesclerk terminal.

As described above, the embodiment of the present invention has an effect that the salesclerk can simultaneously register an order to a plurality of order systems by one operation.

Next, a second embodiment of the present invention will be described in detail. The second embodiment of the present invention is different from the first embodiment on the point that a registration address (URL) of the shop server 30 is transmitted at the same time when the salesclerk transmits the order information of the product to the order reception terminal 20 by the use of the salesclerk terminal 10.

Therefore, the transmission element of the salesclerk terminal 10 transmits the registration address for registering the order information to the shop server 30 to the order reception terminal 20 in addition to the order information.

The transmission element of the order reception terminal 20 transmits the order identification information and the order information to the shop server 30 of the received registration address.

Next, the operation of the embodiment will be described.

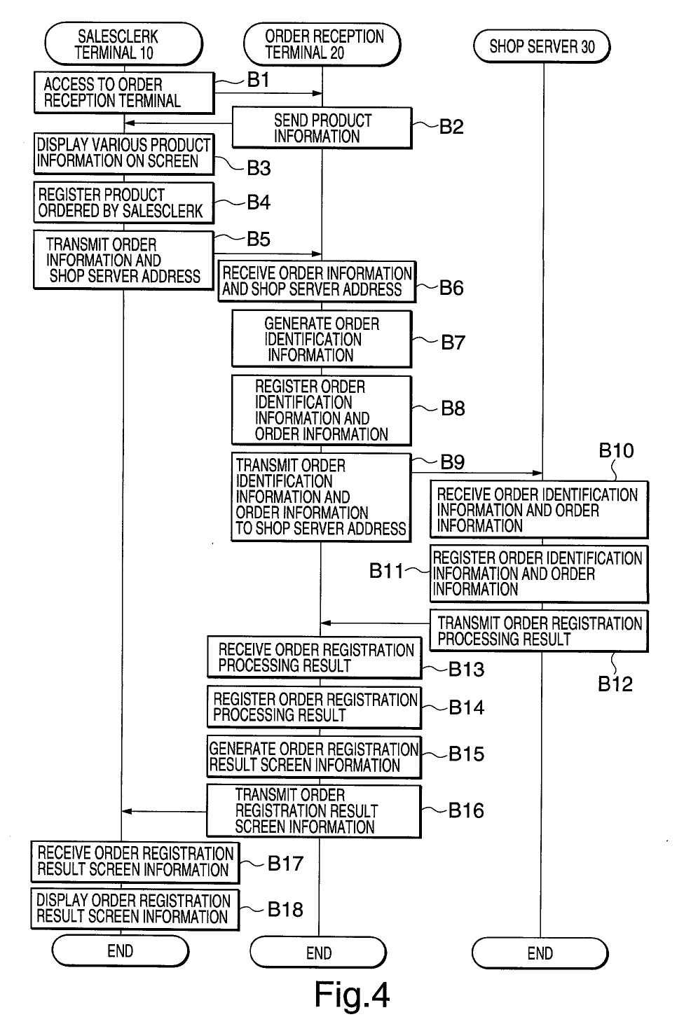

Referring to FIG. 4, the operation to the step where the salesclerk registers the product that he/she wants to order by the use of the salesclerk terminal (step B1 to B4) is the same as the operation (step A1 to A4) in the first embodiment.

The salesclerk terminal 10 transmits the order information and the registration address of the shop server 30 (shop server address) to the order reception terminal 20 via the Internet 100 (step B5).

The order reception terminal 20 receives the order information and the registration address of the shop server 30 (shop server address) (step B6). The following operation to the step where the order reception terminal 20 registers the order (step B7 to B8) is the same as the operation (step A7 to A8) in the first embodiment. The order reception terminal 20 then transmits the order identification information and the order information to the shop server 30 of the registration address (shop server address), which has been received in step B6, via the Internet 100 (step B9).

The following operation (step B10 to B18) is the same as the operation (step A10 to A18) in the first embodiment.

As described above, in the embodiment, since the order information is transmitted to the ordering system of the registration address specified by the salesclerk, there is an effect similar to the first embodiment to a combination of many and unspecified salesclerks and the ordering systems.

Next, a third embodiment of the present invention will be described in detail. The third embodiment of the present invention is different from the second embodiment on the point where the order reception terminal 20 simultaneously transmits a registration result address (URL) when transmitting the order identification information and the order information of the product to the shop server 30.

Therefore, the transmission element of the order reception terminal 20 transmits the registration result address, through which the order reception terminal 20 receives the order registration processing result, to the shop server 30 in addition to the order identification information and the order information.

The shop server 30 includes an element for transmitting the order registration processing result to the order reception terminal 20 of the received registration result address.

Next, the operation of the embodiment will be described.

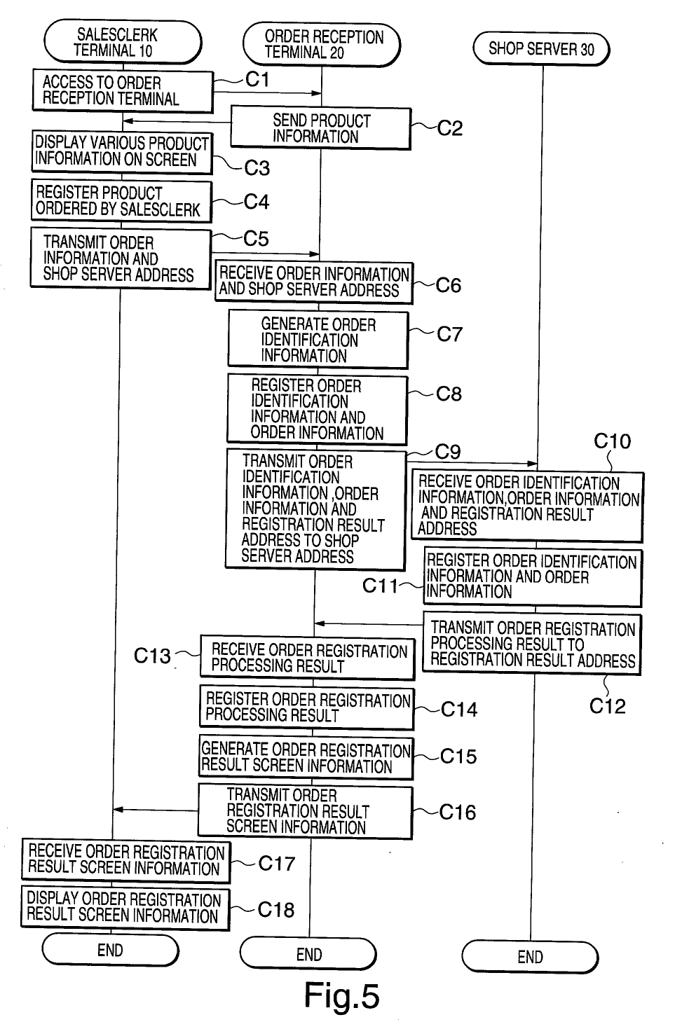

Referring to FIG. 5, the operation to the step where the order reception terminal 20 registers the order (step C1 to C8) is the same as the operation (step B1 to B8) in the second embodiment. The order reception terminal 20 then transmits the order identification information, the order information and the registration result address to the shop server 30 of the registration address, which has been received in step B6, via the Internet 100 (step C9).

The shop server 30, after receiving the order identification information, the order information and the registration result address (step C10), stores them in the order database for order registration (step C11). The shop server 30 transmits the order registration processing result to the registration result address, which has been received in step C10, of the order reception terminal 20 via the Internet 100 (step C12).

The following operation (step C13 to C18) is the same as the operation (step B13 to B18) in the second embodiment.

As in above, in the embodiment, since the address that receives the order registration processing result of one ordering system is transmitted to another ordering system, there is an effect similar to the first embodiment to a combination of many and unspecified ordering systems.

As described above, in the present invention, there is an effect that the salesclerk can simultaneously register orders to a plurality of ordering systems by one operation. The reason is because a registration processing to another ordering system is allowed to be activated upon the order registration to one ordering system.

Moreover, in the present invention, there is an effect that the salesclerk can register orders simultaneously to arbitrary order systems by one operation. The reason is because the addresses for every function of respective ordering systems are transmitted and necessary information is allowed to be transmitted to the respective addresses.

While this invention has been described in conjunction with the preferred embodiments described above, it will be possible for those skilled in the art to put this invention into practice in various other manners.

What is claimed is:

1. A product ordering system, comprising:
a network;
a salesclerk terminal connected to the network;
a shop ordering system connected to the network; and
an order reception system connected to the network, wherein
said salesclerk terminal includes a display element which displays various product information and a transmission element which transmits order information of a product to said order reception system by an instruction of the salesclerk,
said order reception system includes a generation element which generates order identification information to identify said order information in response to reception of said order information, a registration element which registers said order identification information and said order information, and a transmission element which transmits said order identification information and said order information to said shop ordering system, and
said shop ordering system includes a registration element which registers said order identification information and said order information in response to reception of said order identification information and said order information.

2. The product ordering system as claimed in claim 1, wherein
said transmission element of said salesclerk terminal transmits, in addition to said order information, a registration address, which is used to register said order information to said shop ordering system, to said order reception system, and
wherein said transmission element of said order reception system transmits said order identification information and said order information to said shop ordering system based on said registration address.

3. The product ordering system as claimed in claim 2, wherein
said transmission element of said order reception system transmits a registration result address, through which said order reception system receives an order registration processing result, to said shop ordering system in addition to said order identification information and said order information, and
wherein said shop ordering system includes a transmission element which transmits the order registration processing result to said order reception system based on said registration result address.

4. A product ordering method used in a system in which a salesclerk terminal, a shop ordering system and an order reception ordering system are connected via a network, comprising:
displaying various product information on said salesclerk terminal;
transmitting the product order information from said salesclerk terminal to said order reception system according to an instruction of the salesclerk;
generating an order identification information for identifying said order information in said order reception system;
registering said order identification information and said order information in said order reception system;
transmitting said order identification information and said order information to said shop ordering system from said order reception system; and
registering said order identification information and said order information in response to reception of said order identification information and said order information in said shop ordering system.

5. The product ordering method as claimed in claim 4, wherein said salesclerk terminal transmits a registration address, which is used to register said order information to said shop ordering system, to said order reception system in addition to said order information during said transmitting step from said salesclerk terminal to said order reception system, and
wherein said order identification information and said order information are transmitted to said shop ordering system based on said registration address during said transmitting step from said order reception system to said shop ordering system.

6. The product ordering method as claimed in claim 5, wherein said order reception system transmits a registration result address, through which said order reception system receives an order registration processing result, in addition to said order identification information and said order information during said transmitting step from said order reception system to said shop ordering system, and
further comprising: transmitting the order registration processing result to said order reception system from said shop ordering system based on said registration result address.

7. An information processing device used as an order reception system, comprising:
a first receiving element which receives order information transmitted from a salesclerk by using a terminal;
a first generating element which generates order identification information by using said order information;
a registration element which registers said order information and said order identification information;
a first transmission element which transmits said order information and said order identification information to a shop ordering system;
a second receiving element which receives an order registration processing result, which is a result that said shop ordering system registered said order information and said order identification information to the shop ordering system;
a second generating element which generates order registration result screen information to be displayed on said terminal of the salesclerk by using said order registration processing result and the registration result of said registration element; and
a second transmission element which transmits said order registration result screen information to said terminal of the salesclerk.

8. The information processing device as claimed in claim 7, wherein said first receiving element receives said order information and an address of said shop ordering system from the salesclerk by using said terminal, and
wherein said first transmission element transmits said order information and said order identification information to said address.

9. The information processing device as claimed in claim 7, wherein said first transmission element transmits a registration result address, which is a destination to which said shop ordering system transmits the order registration processing result, to said shop ordering system in addition to said order identification information and said order information.
